(19) United States
(12) Patent Application Publication
(10) Pub. No.: US 2018/0176536 A1
(43) Pub. Date: Jun. 21, 2018

(54) ELECTRONIC DEVICE AND METHOD FOR CONTROLLING THE SAME

(71) Applicant: Samsung Electronics Co., Ltd., Gyeonggi-do (KR)

(72) Inventors: Han-Sol JO, Gyeonggi-do (KR); Kyung-Tae Kim, Gyeonggi-do (KR); Keon-Ho Kim, Gyeonggi-do (KR); Sung-Min Yoon, Gyeonggi-do (KR); Seon-Ho Lee, Gyeonggi-do (KR); Chang-Ho Lee, Gyeonggi-do (KR); Sun-Goo Jung, Seoul (KR); Ji-Hoon Chung, Gyeonggi-do (KR); Yoon-Jeong Choi, Seoul (KR); Ho-Seon Lee, Gyeonggi-do (KR); Jae-Seong Hwang, Ulsan (KR)

(73) Assignee: Samsung Electronics Co., Ltd.

(21) Appl. No.: 15/847,320

(22) Filed: Dec. 19, 2017

(30) Foreign Application Priority Data
Dec. 19, 2016 (KR) 10-2016-0173701

(51) Int. Cl. H04N 13/00; H04N 5/232

(52) U.S. Cl. CPC H04N 13/0014; H04N 5/23238; H04N 13/0051; H04N 13/0429; H04N 13/0468; H04N 13/0029

(57) ABSTRACT

An electronic device is provided that includes a display displaying an image and a processor electrically connected with the display. The processor is configured to vary a start position of projection, where the image is played based on a resolution of the display and a resolution of the image, and to resize and display a portion of the image which is displayed on the display.

### PRIORITY

This application claims priority under 35 U.S.C. § 119(a) to Korean Patent Application Serial No. 10-2016-0173701, which was filed in the Korean Intellectual Property Office on Dec. 19, 2016, the entire content of which is incorporated herein by reference.

### BACKGROUND

### 1. Field of the Disclosure

The present disclosure relates generally to electronic devices for displaying images and methods for operating the same.

### 2. Description of the Related Art

As head-mounted devices (HMDs) or other wearable image displays are becoming popular, images and other content with a 360-degree angle of view are emerging. A need exists for easier manipulation of 360-degree images and an improved operational environment.

Electronic devices with 360-degree content take up more data storage resources compared with existing image/video of the same image quality. Although a raw 360-degree video is of a high-definition (HD) class or even higher quality, conversion into a 360-degree mode may deteriorate image quality when actually displayed on an electronic device. For example, when a user accesses a streaming website using a mobile web browser, the website streams out video in a resolution of 360p to 720p. Thus, the video conversion into a 360-degree mode would significantly degrade image quality.

### SUMMARY

According to an aspect of the present disclosure, there may be provided a control method for providing high-quality 360-degree images with various resolutions to the user according to the resolution and an electronic device supporting the same.

Accordingly, an aspect of the present disclosure provides an electronic device which includes a display displaying an image; and a processor electrically connected with the display. The processor is configured to vary a start position of projection, where the image is played based on a resolution of the display and a resolution of the image, and to resize and display a portion of the image which is displayed on the display.

An aspect of the present disclosure provides a method for controlling an electronic device including a display. The method includes identifying a resolution of the display and a resolution of an image played; varying a start position of projection where the image is played based on the resolution of the image; and resizing and displaying a portion of the image which is displayed on the display based on the varied start position of projection.

An aspect of the present disclosure provides a storage medium storing commands to perform a method for controlling an electronic device including a display. The commands identify a resolution of an image played; vary a start position of projection where the image is played based on the resolution of the image; and resize and display a portion of the image which is displayed on the display based on the varied start position of projection.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A to 1D illustrate the start position of projection for playing an image based on the resolution of the image in an electronic device according to an embodiment of the present disclosure;

FIG. 2 illustrates a block diagram of an electronic device according to an embodiment of the present disclosure;

FIGS. 3 and 4 illustrate the structure of a HMD device for playing a 360-degree image according to various embodiments of the present disclosure;

FIG. 5 illustrates a state in which a user wears an HMD device according to an embodiment of the present disclosure;

FIGS. 6A to 6B illustrate an electronic device which displays a varied start position of projection while displaying a 360-degree image according to an embodiment of the present disclosure;

FIGS. 7A to 7C illustrate an electronic device which performs a zooming operation with the start position of projection varied according to an embodiment of the present disclosure;

FIG. 8 is a flowchart illustrating a process for varying the start position of projection based on the resolution of an image in an electronic device according to an embodiment of the present disclosure;

FIG. 9 illustrates an electronic device in a network environment according to an embodiment of the present disclosure;

FIG. 10 illustrates a block diagram of electronic device according to an embodiment of the present disclosure; and

FIG. 11 illustrates a block diagram of a program module according to an embodiment of the present disclosure.

### DETAILED DESCRIPTION

Hereinafter, embodiments of the present disclosure are described with reference to the accompanying drawings. However, it should be appreciated that the present disclosure is not limited to the embodiments and the terminology used herein, and all changes and/or equivalents or replacements thereto also belong to the scope of the present disclosure. The same or similar reference numerals may be used to refer to the same or similar elements throughout the specification and the drawings. It is to be understood that the singular forms “a”, “an”, and “the” include plural references unless the context clearly dictates otherwise. As used herein, the terms “A or B” or “at least one of A and/or B” may include all possible combinations of A and B. As used herein, the terms “first” and “second” may modify various components regardless of importance and/or order, and are used to distinguish a component from another without limiting the components. It will be understood that when an element (e.g., a first element) is referred to as being “operatively or communicatively coupled with/to”, or “connected with/to” another element (e.g., a second element), it can be coupled or connected with/to the other element directly or via a third element.

As used herein, the term “configured to” may be interchangeably used with other terms, such as “suitable for”, “capable of”, “modified to”, “made to”, “adapted to”, “able to”, or “designed to” in hardware or software in the context. The term “configured to” may mean that a device can perform an operation together with another device or parts. For example, the term “processor configured or set to perform A, B, and C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

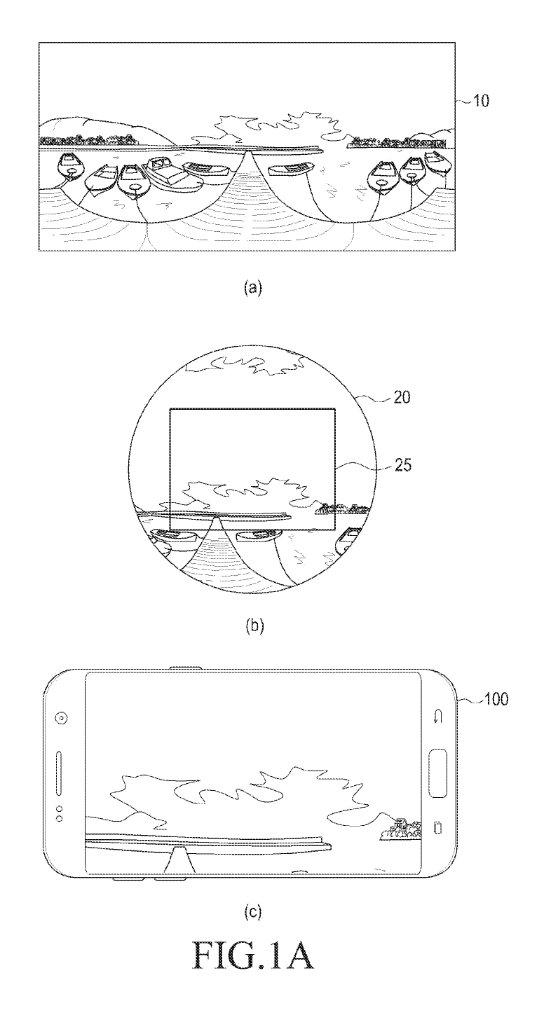

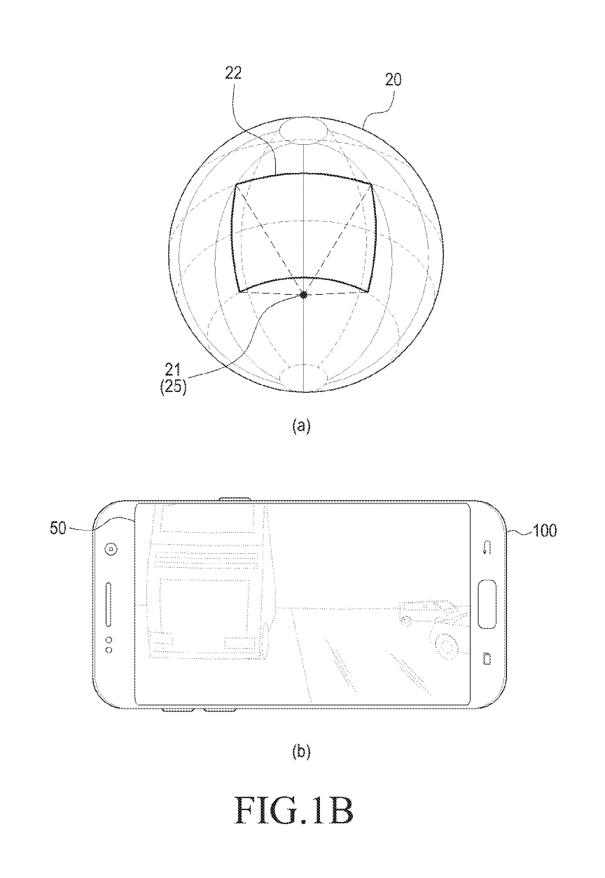

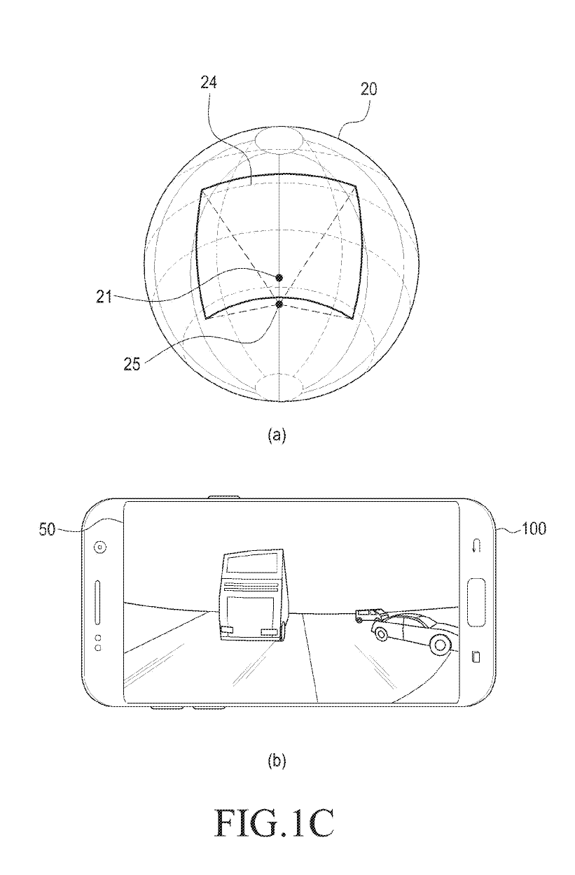

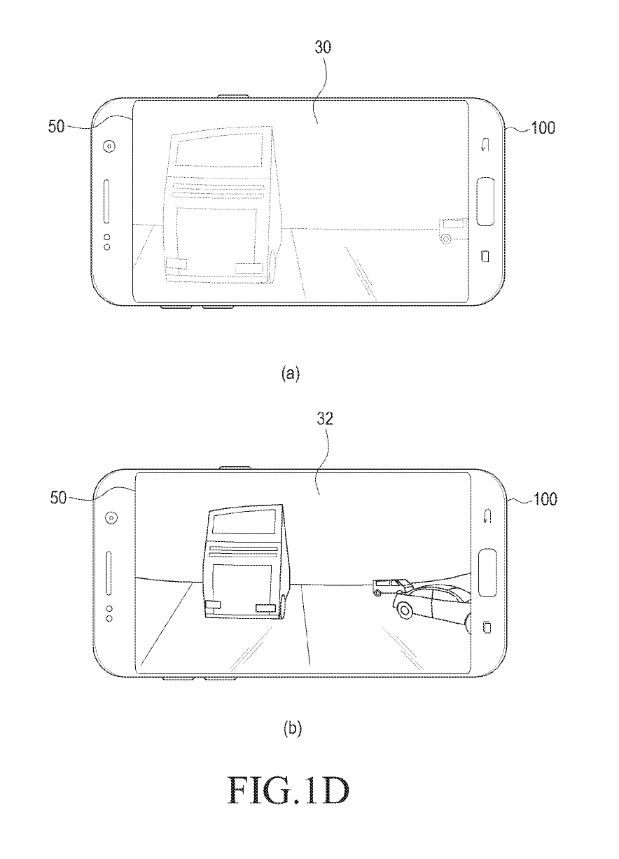

FIGS. 1A to 1D illustrate the start position of projection for playing an image based on the resolution of the image in an electronic device according to an embodiment of the present disclosure;

FIG. 1A illustrates a 360-degree image being generated and adjusted to be displayed on an electronic device.

Referring to FIG. 1A, an electronic device 100 may display a 360-degree image 10. The electronic device according to various embodiments of the present disclosure may include at least one of a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a MP3 player, a medical device, a camera, or a wearable device. The wearable device may include at least one of an accessory-type device (e.g., a watch, a ring, a bracelet, an anklet, a necklace, glasses, contact lenses, or an HMD), a fabric- or clothes-integrated device (e.g., electronic clothes), a body attaching-type device (e.g., a skin pad or tattoo), or a body implantable device.

According to various embodiments of the present disclosure, the smart home appliance may include at least one of a television, a digital versatile disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

Referring to FIG. 1A(a), the 360-degree image 10 may be an image with a 360-degree angle of view. For example, the 360-degree image may be an image generated based on a plurality of images captured in various 360-degree directions using at least one camera. The plurality of images captured may be mapped to a sphere. The contacts of the mapped images may be connected or stitched together, thus generating a spherical 360-degree image. The spherical 360-degree image may be converted into a planar 360-degree image 10, as illustrated in FIG. 1A(a), to be transmitted or stored in another device.

Referring to FIG. 1A(b), according to an embodiment of the present disclosure, the electronic device 100 may perform a graphical process on the planar 360-degree image 10 to convert the planar 360-degree image 10 into a spherical 360-degree image 20. For example, the electronic device 100 may map the planar 360-degree image 10 into a sphere, generating the spherical 360-degree image 20.

Referring to FIG. 1A(c), the electronic device 100 may select a portion 25 of the spherical 360-degree image 20 to display. The electronic device 100 may perform a quality process on the image corresponding to the selected portion 25 and display the quality-processed image on the display.

According to an embodiment of the present disclosure, the electronic device 100 may be integrated with the display. The electronic device 100 may also be configured separately from the display and display images on the display through wired/wireless communication.

According to an embodiment of the present disclosure, the electronic device 100 may be controlled by a control device. For example, the control device may be implemented as various types of devices to control the electronic device 100, such as a remote controller or smartphone.

According to an embodiment of the present disclosure, the control device may control the electronic device 100 using short-range communication technology including infrared (IR) or Bluetooth™ communication technology. The control device may control the function of the electronic device 100 using at least one of its keys (e.g., a buttons), a touch pad, a microphone capable of receiving the user's voice, and a sensor capable of recognizing the motion of the control device.

According to an embodiment of the present disclosure, the image played by the electronic device 100 is not limited to a 360-degree image. For example, the electronic device 100 may play a panorama image. The panorama image may be an image generated based on a plurality of images captured by at least one camera while varying the direction of the image capture. The panorama image may be generated in a manner similar to that used to generate the above-described 360-degree image, but the panorama image may be one imaged at various angles of view, e.g., 30 degrees, 90 degrees, and 180 degrees. The electronic device 100 may play a planar image with a fixed angle of view. In the following description, the electronic device 100 is assumed to play 360-degree images.

FIG. 1B illustrates an electronic device displaying part of a 360-degree image according to an embodiment of the present disclosure.

Referring to FIG. 1B(a), the electronic device 100 may display a portion of a 360-degree image. The electronic device 100 may select a portion 22 of the spherical 360-degree image 20 and display an image corresponding to the selected portion 22 on the display 50. The portion 22 may be an area within a predetermined angular range with respect to the center 21 of the spherical 360-degree image 20. The center 21 of the spherical 360-degree image 20 may be, e.g., a position where the imaging device was located when capturing the spherical 360-degree image 20.

According to an embodiment of the present disclosure, the electronic device 100 may display, on the display 50, an area corresponding to the angle of view set with respect to the center 21 of the spherical 360-degree image 20. For example, the center 21 of the spherical 360-degree image 20 may be a start position 25 of projection where the image is displayed on the display. The electronic device 100 may display an area corresponding to an angle of view of about 96 degrees on the display. However, the angle of view at which the electronic device 100 displays images on the display is not limited thereto. The electronic device 100 may vary the angle of view at which an image is displayed based on the characteristics of the display of the electronic device 100. For example, the electronic device 100 may display an area corresponding to an angle of view between 100 degrees and 120 degrees on the display.

When the electronic device 100 displays a portion of the 360-degree image on the display 50 with respect to the center 21 of the 360-degree image, the displayed image may look poorer in quality than the 360-degree image. The quality of an image may be assessed, e.g., by the number of pixels included in the image. As an image has more pixels, the image may be a higher-quality one, and as an image has less pixels, the image may be a lower-quality one. The number of pixels in an image may be represented by multiplying the number of horizontal pixels in the image by the number of vertical pixels in the image.

FIG. 1B(b) illustrates the portion 22 of the 360-degree image 20 as displayed by the electronic device 100. For example, when the 360-degree image 20 is a (640×360)-pixel quality image, the portion 22 displayed by the electronic device may be shown to have less than 160 horizontal pixels. Thus, the user views an image with 160 horizontal pixels instead of an image captured to have 640 horizontal pixels. As such, the image that the user views is has deteriorated quality compared with the raw image.

FIG. 1C illustrates an electronic device which varies the position of the center for playing a 360-degree image and displays the image according to an embodiment of the present disclosure.

Referring to FIG. 1C(a), the electronic device 100 may display a portion of a 360-degree image. The electronic device 100 may select a portion 24 of the spherical 360-degree image 20 and display an image corresponding to the selected portion 25 on the display.

According to an embodiment of the present disclosure, the electronic device 100 may vary the start position 25 of projection given the resolution of the 360-degree image that the electronic device 100 plays. For example, the electronic device 100 may choose a position that is a predetermined distance away from the center 21 of the spherical 360-degree image 20 as the start position 25 of projection. The electronic device 100 may shift the start position 25 of projection along the direction in which the image is projected or its opposite direction with respect to the center 21.

According to an embodiment of the present disclosure, the electronic device 100 may calculate the distance at which the start position of projection shifts using Equation (1) below:

$$Distance shifted = R * ( 1 - k ( \frac{( Resolution of raw 360 \text{-} degree image )}{( Maximum resolution that electronic device can play )} ) ) \qquad ( 1 )$$

R=the radius of the 360-degree image

k=a constant for adjusting the distance at which the start position of projection shifts given an image distortion

For example, assuming that the radius of the 360-degree image 20 is 1, k is 1, the maximum resolution that the electronic device 100 may play is 2180 pixels wide, and the resolution of raw 360-degree image 20 is 640 pixels wide, the electronic device 100 may vary the start position 25 of projection from where the 360-degree image with a radius of 1 is projected to an opposite direction in which an image with a radius of about 0.71 is projected according to Equation (1) above.

FIG. 1C(c) illustrates an electronic device 100 which displays a portion 24 of a 360-degree image 20 with respect to the varied start position of projection. When the start position of projection is shifted based on Equation [1], the electronic device 100 may display a portion 24 corresponding to about 270 horizontal pixels.

For example, when the electronic device 100 varies the start position 25 of projection based on the resolution of the 360-degree image 20, the user may view an image with 270 horizontal pixels instead of an image with 160 horizontal pixels that the user would see as per the conventional art.

According to an embodiment of the present disclosure, the electronic device 100 may calculate the distance at which the start position of projection shifts using Equation (2) as follows. Equation (2) may further consider the minimum resolution of the electronic device 100. The minimum resolution may be, e.g., a resolution set by the manufacturer of the electronic device 100. The minimum resolution may be a value determined given that an image with a resolution of pixels fewer than the minimum resolution may not meet the quality standards for the user to view.

The minimum resolution may be, e.g., 160 pixels wide. However, the minimum resolution is not limited thereto. A different value may be set to the minimum resolution given the maximum resolution that the electronic device 100 may play or the capability of the electronic device 100 in relation to the playing of other images.

$$Distance shifted = R * ( 1 - k ( \frac{\begin{matrix}( Resolution of raw 360 \text{-} degree image ) - \\ ( Minimum resolution )\end{matrix}}{\begin{matrix}( Maximum resolution that electronic device can play ) - \\ ( Minimum resolution )\end{matrix}} ) ) \qquad ( 2 )$$

R=the radius of the 360-degree image

k=a constant for adjusting the distance at which the start position of projection shifts given an image distortion

For example, assuming that the radius of the 360-degree image 20 is 1, k is 1, the minimum resolution is 160 pixels, the maximum resolution that the electronic device 100 may play is 2180 pixels wide, and the resolution of raw 360-degree image 20 is 640 pixels wide, the electronic device 100 may vary the start position 25 of projection from where the 360-degree image with a radius of 1 is projected to an opposite direction in which an image with a radius of about 0.76 is projected according to the above Equation (2).

FIG. 1C(b) illustrates where the electronic device 100 displays a portion 24 of a 360-degree image 20 with respect to the varied start position of projection. When the start position of projection is shifted based on Equation (2), the electronic device 100 may display a portion 24 corresponding to about 270 horizontal pixels. As such, the electronic device 100 may vary the start position 25 of projection in various manners based on the resolution of the 360-degree image 20, allowing the user to view higher-quality images.

FIG. 1D illustrates an electronic device which displays part of a 360-degree image according to an embodiment of the present disclosure.

FIG. 1D(a) illustrates the electronic device 100 which displays a portion 30 of a 360-degree image on the display 50. When the 360-degree image is an image of (1280×720) pixels, the portion 30 the electronic device displays may be displayed as having about 320 horizontal pixels. For example, the user views an image with 320 horizontal pixels instead of an image captured to have 1280 horizontal pixels.

According to an embodiment of the present disclosure, the electronic device 100 may vary the start position of projection given the resolution of the 360-degree image that the electronic device 100 plays. For example, the electronic device 100 may choose a position that is a predetermined distance away from the center of the spherical 360-degree image as the start position of projection. The electronic device 100 may shift the start position of projection in an opposite direction from the projection of image with respect to the center.

According to an embodiment of the present disclosure, the electronic device may calculate the distance at which the start position of projection shifts using Equation (1) above.

For example, assuming that the radius of the 360-degree image is 1, k is 1, the maximum resolution that the electronic device 100 may play is 2180 pixels wide, and the resolution of a raw 360-degree image 20 is 1280 pixels wide, the electronic device 100 may vary the start position 25 of projection from where the 360-degree image with a radius of 1 is projected to an opposite direction in which an image with a radius of about 0.41 is projected according to Equation (1) above.

FIG. 1D(b) illustrates the electronic device 100 which displays a portion of a 360-degree image on the display 50 with respect to the varied start position of projection. When the start position of projection is shifted based on Equation (1), the electronic device 100 may display a portion 32 corresponding to about 430 horizontal pixels. For example, when the electronic device 100 varies the start position of projection based on the resolution of the 360-degree image, the user may view an image with 430 horizontal pixels instead of an image with 320 horizontal pixels that the user would see as per the conventional art.

According to an embodiment of the present disclosure, the electronic device 100 may calculate the distance at which the start position of projection shifts using Equation (2). Equation (2) may further consider the minimum resolution that the electronic device 100 may offer the user. The minimum resolution may be, e.g., a resolution set by the manufacturer of the electronic device 100. The minimum resolution may be a value determined given that an image with a resolution of pixels fewer than the minimum resolution may not meet the quality standards for the user to view.

The minimum resolution may be, e.g., 160 pixels wide. However, the minimum resolution is not limited thereto. A different value may be set to the minimum resolution given the maximum resolution that the electronic device 100 may play or the capability of the electronic device 100 in relation to the playing of other images.

For example, assuming that the radius of the 360-degree image is 1, k is 1, the minimum resolution is 160 pixels, the maximum resolution that the electronic device 100 may play is 2180 pixels wide, and the resolution of a raw 360-degree image 20 is 1280 pixels wide, the electronic device 100 may vary the start position of projection from where the 360-degree image with a radius of 1 is projected to an opposite direction in which an image with a radius of about 0.45 is projected according to Equation (2) above.

FIG. 1D(b) illustrates the electronic device 100 which displays a portion 32 of a 360-degree image on the display 50 with respect to the varied start positions of projection. When the start position of projection is shifted based on Equation (2), the electronic device 100 may display a portion corresponding to about 460 horizontal pixels. As such, the electronic device 100 may vary the start position of projection in various manners based on the resolution of the 360-degree image, allowing the user to view higher-quality images.

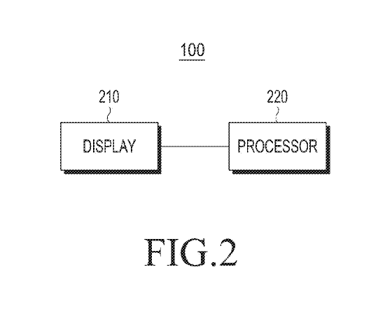

FIG. 2 illustrates a block diagram of an electronic device according to an embodiment of the present disclosure.

Referring to FIG. 2, an electronic device 100 may include a display 210 and a processor 220. However, the electronic device 100 may be implemented to include more or less than the components shown in FIG. 2. For example, the electronic device 100 may include an input module (e.g., a physical key, a proximity sensor, or biometric sensor) or a power supply. The electronic device 100 may also include a memory capable of storing commands or data associated with at least one other component.

The display 210 may include, e.g., a liquid crystal display (LCD), a light emitting diode (LED) display, an organic light emitting diode (OLED) display, a microelectromechanical systems (MEMS) display, or an electronic paper display. The display 210 may include a touchscreen and may receive, e.g., a touch, a gesture, a proximity or a hovering input using an electronic pen or a body portion of the user. According to an embodiment of the present disclosure, the display 210 may display an image corresponding to a portion of a 360-degree image under the control of the processor 220. The image displayed on the display 210 may be an image processed for image quality.

The processor 220 may control multiple hardware and software components connected to the processor 220 by running, e.g., an operating system (OS) or application programs, and the processor 210 may process and compute various data.

According to an embodiment of the present disclosure, the processor 220 may perform control to display a portion of a 360-degree image on the display 210 using 360-degree image data stored in the memory. For example, the processor 220 may control the display 210 with a portion corresponding to an angle of view of 96 degrees in a horizontal direction of a 360-degree image or a portion corresponding to an angle of view of 120 degrees in the horizontal direction.

According to an embodiment of the present disclosure, the processor 220 may vary the start position of projection for displaying a 360-degree image based on the resolution of the 360-degree image. As the processor 220 varies the start position of projection, the portion of the 360-degree image which is displayed on the display 210, may be resized.

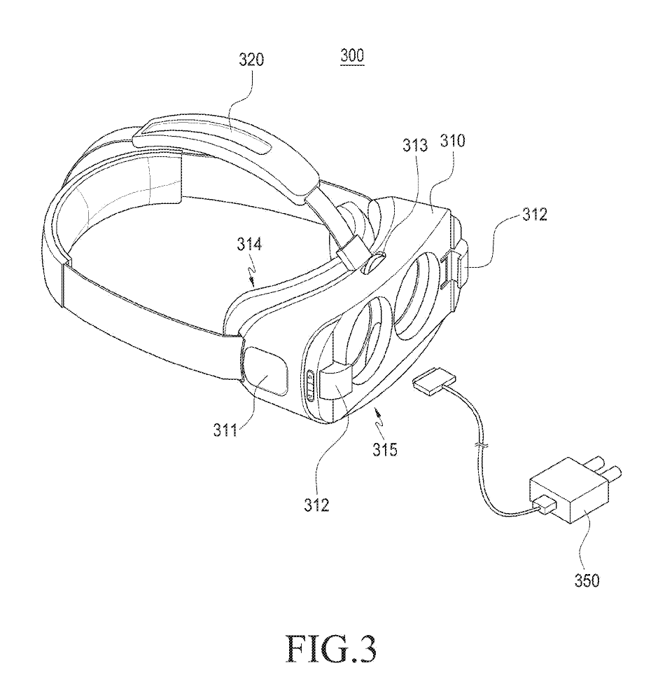

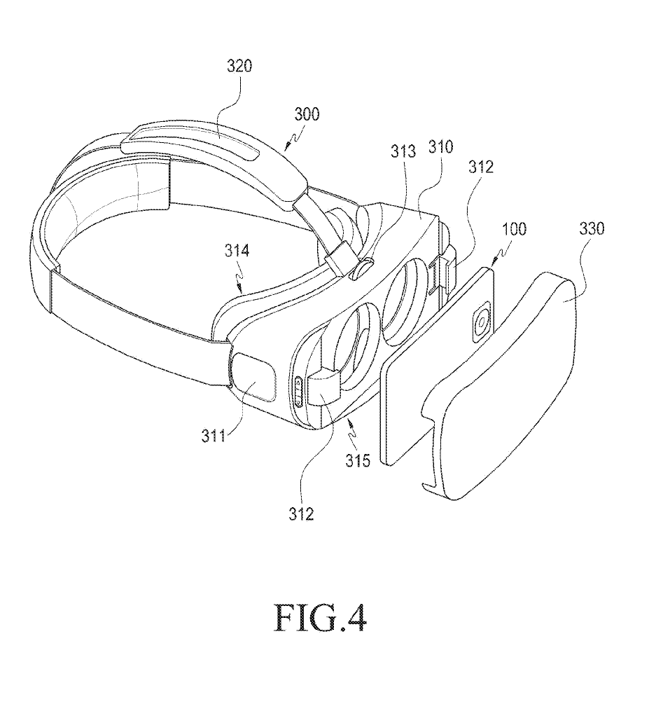

FIGS. 3 and 4 illustrate the structure of a HMD device for playing a 360-degree image according to various embodiments of the present disclosure.

Referring to FIGS. 3 and 4, an electronic device 100 may be connected with an HMD device to provide images to the user.

Referring to FIG. 3, the HMD device 300 may include a main frame 310 configured to be detachably connected with an electronic device 100 and a mount 320 connected with the main frame 310 to fasten the main frame 310 to a user's head.

The main frame 310 may include a user input module 311 for controlling the electronic device 100, a first interface unit 312 connected with the electronic device 100, a display position adjuster 313, a proximity sensor 314, and a second interface unit 315 connected with an external power supply 350 or another external input device.

According to an embodiment of the present disclosure, the user input module 311 may include at least one of a physical key, a physical button, a touch key, a joystick, a wheel key, or a touch pad. When the user input module 311 is a touch pad, the touch pad may be disposed on a side surface of the main frame 310. The touch pad may include a control object (e.g., a graphical user interface (GUI) for controlling sound or an image) to represent the function of the electronic device 100 or the HMD device 300.

The first interface unit 312 may support the HMD device 300 to communicate with the electronic device 100. The first interface unit 312 may be connected to an interface unit (e.g., a universal serial bus (USB) port) of the electronic device 100. The first interface unit 312 may transfer a user input signal generated from the user input module 311 to the electronic device 100. For example, the first interface unit 312 may transmit a user input signal (e.g., a touch input) received from the user input module 311 to the electronic device 100. The electronic device 100 may perform a function corresponding to the user input signal. For example, the electronic device 100 may adjust the volume or play an image in response to the touch input.

The proximity sensor 314 may detect the position of an object without making contact with the object. For example, upon sensing an object (e.g., the user's head) within a preset sensing distance, the proximity sensor 314 may transfer a sensed signal to the main controller of the HMD device 300. Upon failure to sense an object within the predetermined sensing distance, the proximity sensor 314 may send no signal to the main controller. The main controller may determine that the user wears the HMD device 300 based on the signal sensed by the proximity sensor 314. For example, to easily detect whether the HMD device 300 is worn, the proximity sensor 314 may be provided on an upper portion of the inside of the main frame 310 to be placed adjacent to the user's forehead when the user wears the HMD device 300.

Although the proximity sensor is used herein, other sensors capable of detecting whether the HMD device 300 is worn may alternatively be used. For example, at least one or more of an acceleration sensor, a gyro sensor, a geo-magnetic sensor, a gesture sensor, a bio or biometric sensor, a touch sensor, an illumination or illuminance sensor, or a grip sensor may be mounted in the main frame 310.

The second interface unit 315 may be connected with the external power supply 350 or another external input device. For example, when the second interface unit 315 may be connected to the external power supply 350, and the HMD device 300 may receive power from the external power supply 350. The received power may be used to operate the HMD device 300 or may be transferred to the electronic device 100 to be used to operate or charge the electronic device 100. When the second interface unit 315 is connected with an external input device, the HMD device 300 may receive an external input signal from an external input device and transfer the external input signal to the main controller of the HMD device 300.

The main frame 310 may be detachably configured with an external device, e.g., the electronic device 100. For example, the main frame 310 may include a space, structure, or cavity to receive the electronic device 100. The part of the main frame 310 forming the space may include an elastic material. The part of the main frame 310 forming the space may be, at least partially, formed of a flexible material to change the size or volume of the space depending on the various sizes of devices to be received in the space.

A rear surface (e.g., inner surface) of the main frame 310 may further include a face contact part that contacts the user's face. A lens assembly including at least one lens may be inserted into part of the face contact part on the rear surface (e.g., inner surface) of the main frame 310 to be positioned facing the user's eyes. In the lens assembly, a display or transparent/translucent lens may be integrally formed with the face contact part. The lens assembly may be detachably provided to the face contact part. Part of the face contact part may include a nose recess shaped to seat on the user's nose.

According to an embodiment of the present disclosure, the main frame 310 may include a material, e.g., plastic, to allow the user to comfortably wear the HMD device 300 and to support the electronic device 100. The main frame 310 may include at least one material of glass, ceramic, metal (e.g., aluminum), or a metal alloy (e.g., a steel, stainless steel, titanium, or magnesium alloy) for better strength or improved appearance.

The mount 320 may be worn on the user's body part. The mount 320 may include an elastic band. According to an embodiment of the present disclosure, the mount 320 may include eyeglass temples, a helmet, or a strap.

FIG. 4 illustrates an assembly of an HMD device and an electronic device according to an embodiment of the present disclosure.

Referring to FIG. 4, the HMD device 300 may further include a cover 330 to fasten the electronic device 100 which is in turn coupled with the main frame 310. The cover 330 may be coupled to the main frame 310 physically, e.g., with a hook, or by way of magnets or electromagnets. The cover 330 may prevent the electronic device 100 from falling off the main frame 310 due to the user's motion and protect the electronic device 100 from external impacts.

The main frame 310 and the display of the electronic device 100 may be coupled together such that they face each other. The user may couple the HMD device 300 with the electronic device 100 by putting the electronic device 100 into the first interface unit 312 of the main frame 310 and then fitting the cover 330 thereover.

FIG. 5 illustrates a state in which a user wears an HMD device according to an embodiment of the present disclosure.

Referring to FIG. 5, when the user wears the HMD device 300 which has been coupled with the electronic device 100 and covered by cover 330, the user may view the screen of the electronic device 100 through the HMD device 300. In this case, the electronic device 100 may output an image for the left eye and an image for the right eye on the display. The HMD device 300 may process the images from the electronic device 100 through the lens assembly provided in the face contact part of the main frame 310, allowing the user to view the processed images, e.g., experience virtual reality (VR) using an augmented reality (AR) function or a see-through function.

An HMD device may include an untethered VR scheme that uses the display of an external electronic device and a tethered VR scheme in which the HMD device has its own display. The above-described method for driving the electronic device 100 and the HMD device 300 may be an untethered VR scheme-based driving method.

According to an embodiment of the present disclosure, the HMD device 300 may include a tethered VR scheme. The tethered VR scheme-based HMD device 300 may include a display capable of playing content. For example, the tethered VR scheme-based HMD device 300 may play content even with no mechanical connection with the electronic device 100. For example, the tethered VR scheme-based HMD device 300 may receive high-definition image data generated by the electronic device 100 through a connector and output (e.g., mirroring) the image data through its own display.

The tethered VR scheme-based HMD device 300 and the electronic device 100 may be connected together through various image communication interfaces. The image data interfaced may be, e.g., the high-definition multimedia interface (HDMI), the mobile high-definition link (MHL), the USB audio video device interface, or other similar image communication interface standards. Image data may also follow each manufacturer's own standards.

The image data may be delivered through a connector. For example, the rx, tx, or other data terminals of a USB type-C connector may be used to deliver image data. The present disclosure is not limited to a particular type of wired communication interface and connector as used by the HMD device 300 and the electronic device 100.

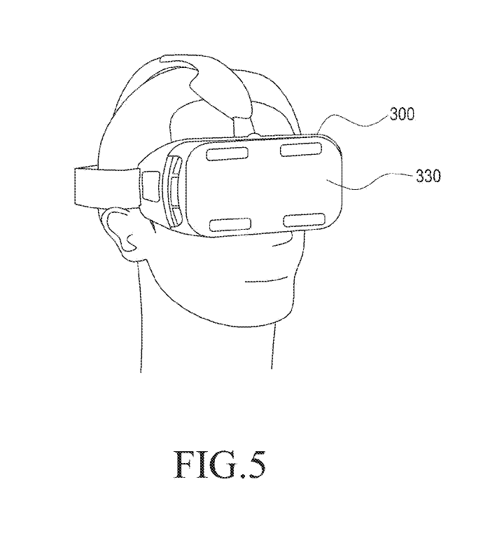

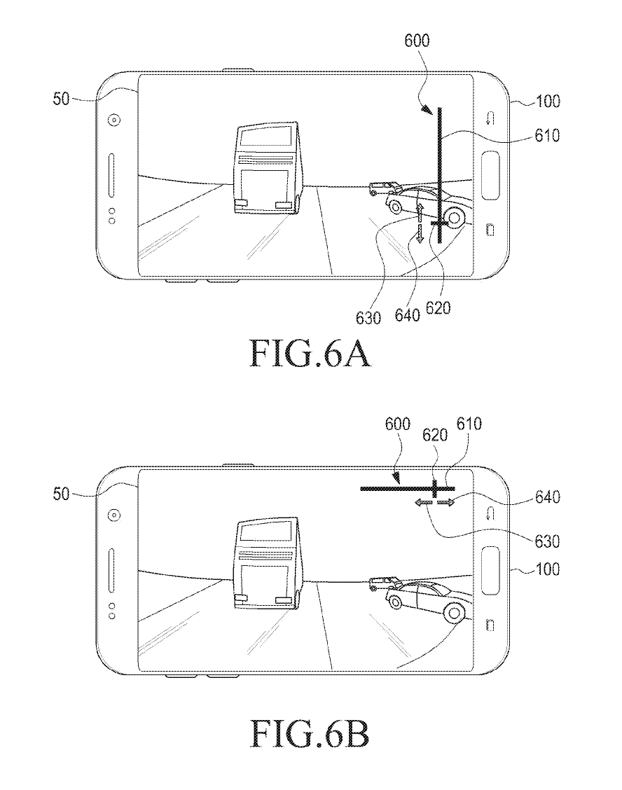

FIGS. 6A to 6B illustrate an electronic device which displays a varied start position of projection while displaying a 360-degree image according to an embodiment of the present disclosure.

Referring to FIGS. 6A to 6B, the electronic device 100 may display, on the display 50, a portion of a 360-degree image 20 with respect to a varied start position of projection. The electronic device 100 may display a user interface 600 that indicates an approximate varied start position of projection.

Referring to FIGS. 6A to 6B, the electronic device 100 may display the user interface 600, which indicates the varied start position of projection, on the portion (e.g., a right portion, or upper and right portion) of the displayed image. According to an embodiment of the present disclosure, the position of the user interface 600 which indicates the start position of projection is not limited thereto. For example, the electronic device 100 may display the user interface 600 indicating the start position of projection on a lower portion or left portion of the displayed image. The electronic device 100 may vary the position of the user interface 600 indicating the start position of projection based on an input signal from the user.

The user interface 600 may include a first component 610 and a second component 620. The first component 610 may represent an overall range where the start position of projection is variable. The second component 620 may represent a current start position of projection.

According to an embodiment of the present disclosure, the electronic device 100 may play a 360-degree image 20 with respect to the center of the 360-degree image and may then vary the start position of projection given the resolution of the 360-degree image 20. In this case, the electronic device 100, after displaying the image, may vary the start position of projection while displaying the image. The electronic device 100 may display the user interface 600 that indicates the start position of projection. However, the present disclosure is not limited thereto. For example, before starting to play the 360-degree image 20, the electronic device 100 may vary the start position of projection given the resolution of the 360-degree image and may then display the image. The electronic device 100 may display the user interface 600 that indicates the start position of projection.

According to an embodiment of the present disclosure, the user may vary the start position of projection. For example, when the user interface 600 indicating the start position of projection is displayed on the touch display of the electronic device 100, the user may manipulate (e.g., touch-and-drag) the second component 620 of the user interface 600 to vary the start position of projection. For example, when the user shifts the second component 620 in a first direction 630, the start position of projection may be shifted in a direction close to the center of the 360-degree image 20. When the user shifts the second component 620 in a second direction 640, the start position of projection may be shifted in a direction away from the center of the 360-degree image 20. The user may shift the position of the second component 620 in the first direction 630 or second direction 640 by entry of a separate physical key, varying the start position of projection.

According to an embodiment of the present disclosure, when the user views the 360-degree image through an HMD device 300 electrically connected with the electronic device 100, the user may vary the start position of projection using an input device (e.g., the user input module 311) provided in the HMD device 300. When the user wearing the HMD device 300 moves his/her head, the electronic device 100 may sense the movement of the HMD device 300 and vary the start position of projection based on the sensed movement.

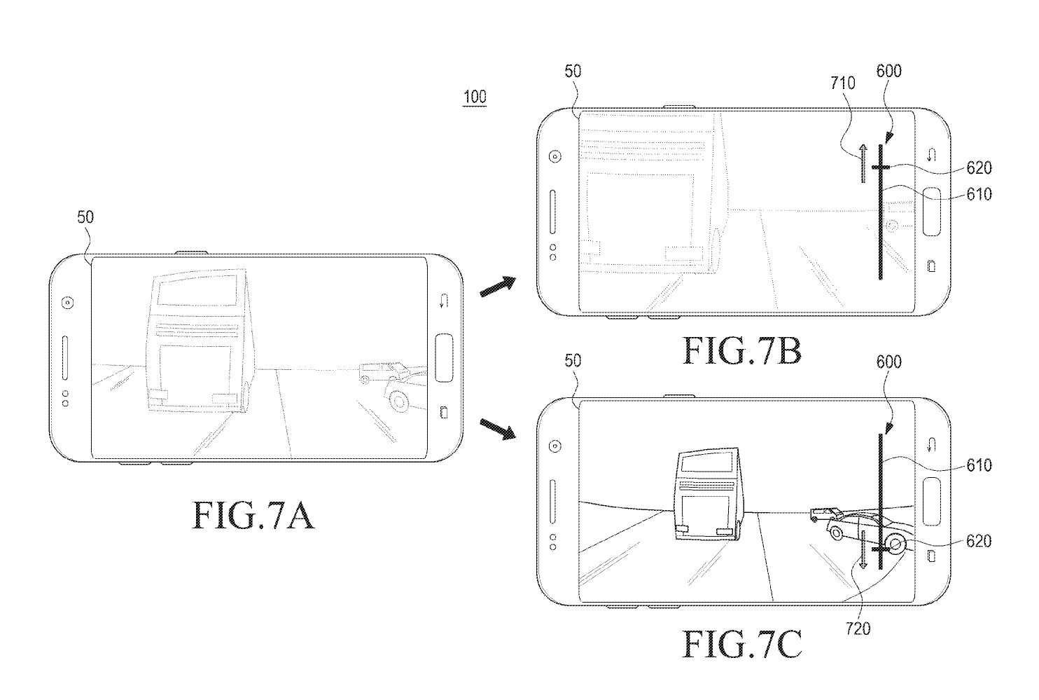

FIGS. 7A to 7C illustrate an electronic device 100 which performs a zooming operation with the start position of projection varied according to an embodiment of the present disclosure.

Referring to FIG. 7A, the electronic device 100 may display a portion of a 360-degree image 20. The electronic device 100 may choose a portion of the spherical 360-degree image 20 and display an image corresponding to the selected portion 25 on the display 50.

Referring to FIG. 7B, the electronic device 100 may perform a zoom-in operation and zoom-out operation based on the operation of varying the start position of projection. For example, when the user shifts the second component 620 of the user interface 600 indicating the start position of projection in the first direction 710, the electronic device 100 may perform the zoom-in operation that gradually enlarges and displays the center of the image displayed on the display 50.

Referring to FIG. 7C, when the user shifts the second component 620 of the user interface 600 indicating the start position of projection in the second direction 720, the electronic device 100 may perform the zoom-out operation that gradually shrinks and displays the center of the image displayed on the display 50 while allowing the previously outlaying objects to be viewed.

According to an embodiment of the present disclosure, when the user views a 360-degree image through an HMD device 300 electrically connected with the electronic device 100, the user may perform the zoom-in operation and zoom-out operation while shifting the position of the second component 620 using the user input module 311 provided in the HMD device 300. When the user moves their head or entire body either forwards or backwards while wearing the HMD device 300, the electronic device 100 may perform the zoom-in operation and zoom-out operation based on the movement of the HMD device 300.

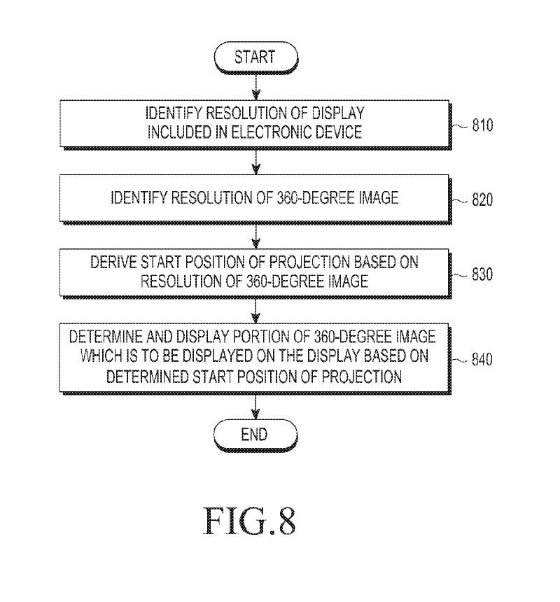

FIG. 8 is a flowchart illustrating a process for varying the start position of projection based on the resolution of an image in an electronic device according to an embodiment of the present disclosure.

In step 810, the electronic device 100 may identify the resolution of the display of the electronic device 100. The electronic device 100 may identify the horizontal-vertical ratio of the display. The electronic device 100 may resize or correct an image that it is to play based on the identified horizontal-vertical ratio and resolution of the display.

In step 820, the electronic device 100 may identify the resolution of a 360-degree image. In step 830, the electronic device 100 may derive the start position of projection based on the identified resolution of the 360-degree image. For example, the electronic device 100 may make such a configuration that the viewpoint of projection of the image is the same as the viewpoint of capture of the 360-degree image. For example, when the resolution of the 360-degree image is low, the electronic device 100 may shift the start position of projection in an opposite direction of the direction of projection of the image with respect to the viewpoint of capture and may then play the 360-degree image.

In step 840, the electronic device 100 may determine and display a portion of the 360-degree image on the display based on the determined start position of projection. For example, when the electronic device 100 determines that the angle of view of playing the 360-degree image is 96 degrees, the electronic device 100 may derive and display, on the display, a portion corresponding to the 96 degrees with respect to the varied start position of projection.

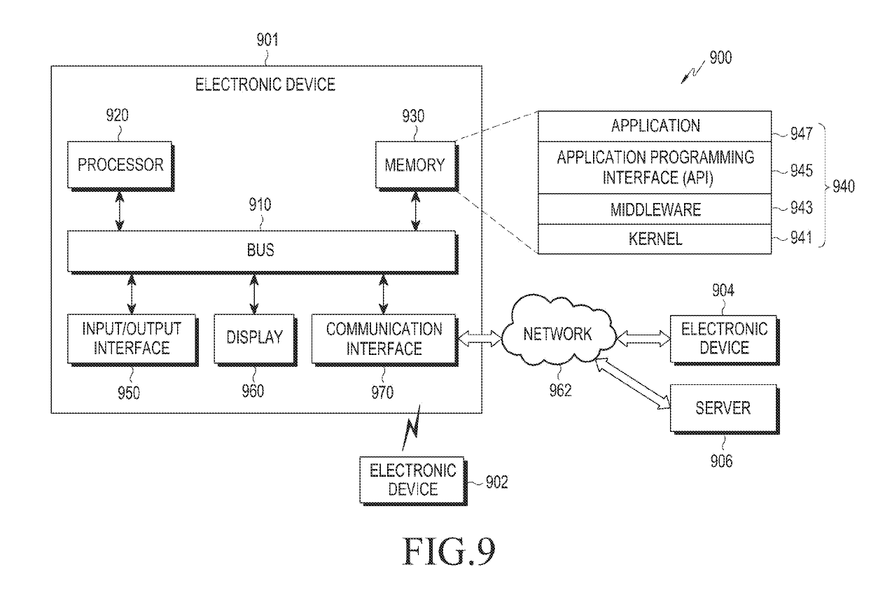

FIG. 9 illustrates an electronic device in a network environment according to an embodiment of the present disclosure.

Referring to FIG. 9, according to an embodiment of the present disclosure, an electronic device 901 is included in a network environment 900. The electronic device 901 may include a bus 910, a processor 920, a memory 930, an input/output interface 950, a display 960, and a communication interface 970. The electronic device 901 may include the electronic device 100. In various embodiments of the present disclosure, the electronic device 901 may exclude at least one of the components or may add another component. The bus 910 may include a circuit for connecting the components 920 to 970 with one another and transferring communications (e.g., control messages or data) between the components. The processor 920 may include one or more of a CPU, an AP, or a communication processor (CP). The processor 920 may perform control on at least one of the other components of the electronic device 901, and/or perform an operation or data processing relating to communication.

The memory 930 may include a volatile and/or non-volatile memory. For example, the memory 930 may store commands or data related to at least one other component of the electronic device 901. According to an embodiment of the present disclosure, the memory 930 may store software and/or a program 940. The program 940 may include, e.g., a kernel 941, middleware 943, an application programming interface (API) 945, and/or applications 947. At least a portion of the kernel 941, middleware 943, or API 945 may be denoted as an OS. For example, the kernel 941 may control or manage system resources (e.g., the bus 910, processor 920, or a memory 930) used to perform operations or functions implemented in other programs (e.g., the middleware 943, API 945, or applications 947). The kernel 941 may provide an interface that allows the middleware 943, the API 945, or the applications 947 to access the individual components of the electronic device 901 to control or manage the system resources.

The middleware 943 may function as a relay to allow the API 945 or the applications 947 to communicate data with the kernel 941, for example. Further, the middleware 943 may process one or more task requests received from the applications 947 in order of priority. For example, the middleware 943 may assign a priority of using system resources (e.g., bus 910, processor 920, or memory 930) of the electronic device 901 to at least one of the applications 947 and process one or more task requests. The API 945 is an interface allowing the applications 947 to control functions provided from the kernel 941 or the middleware 943. For example, the API 945 may include at least one interface or function (e.g., a command) for filing control, window control, image processing, or text control. For example, the input/output interface 950 may transfer commands or data input from the user or other external device to other component(s) of the electronic device 901 or may output commands or data received from other component(s) of the electronic device 901 to the user or other external devices.

The display 960 may include, e.g., an LCD, an LED display, an OLED display, a MEMS display, or an electronic paper display. The display 960 may display, e.g., various contents (e.g., text, images, videos, icons, or symbols) to the user. The display 960 may include a touchscreen and may receive, e.g., a touch, gesture, proximity, or hovering input using an electronic pen or a body portion of the user.

The communication interface 970 may set up communication between the electronic device 901 and an external electronic device (e.g., a first electronic device 902, a second electronic device 904, or a server 906). For example, the communication interface 970 may be connected with the network 962 through wireless or wired communication to communicate with the external electronic device (e.g., the second external electronic device 904 or server 906).

The wireless communication may include cellular communication which uses at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM). According to an embodiment of the present disclosure, the wireless communication may include at least one of, e.g., wireless fidelity (Wi-Fi), Bluetooth™, Bluetooth low power (BLE), zigbee, near field communication (NFC), magnetic secure transmission (MST), radio frequency, or body area network (BAN). The wireless communication may include global navigation satellite system (GNSS). The GNSS may be, e.g., global positioning system (GPS), global navigation satellite system (Glonass), Beidou navigation satellite system (Beidou), or Galileo, the European global satellite-based navigation system. Hereinafter, the terms “GPS” and the “GNSS” may be interchangeably used herein. The wired connection may include at least one of, e.g., USB, high definition multimedia interface (HDMI), recommended standard (RS)-232, power line communication (PLC), or plain old telephone service (POTS). The network 962 may include at least one of telecommunication networks, e.g., a computer network (e.g., local area network (LAN) or wide area network (WAN)), Internet, or a telephone network.

The first and second external electronic devices 902 and 904 each may be a device of the same or a different type from the electronic device 901. According to an embodiment of the present disclosure, all or some of operations executed on the electronic device 901 may be executed on another or multiple other electronic devices (e.g., the electronic devices 902 and 904, or server 906). When the electronic device 901 should perform some function or service automatically or at a request, the electronic device 901, instead of executing the function or service on its own or additionally, may request another device to perform at least some functions associated therewith. The other electronic device) may execute the requested functions or additional functions and transfer a result of the execution to the electronic device 901. The electronic device 901 may provide a requested function or service by processing the received result as it is or additionally. To that end, a cloud computing, distributed computing, or client-server computing technique may be used, for example.

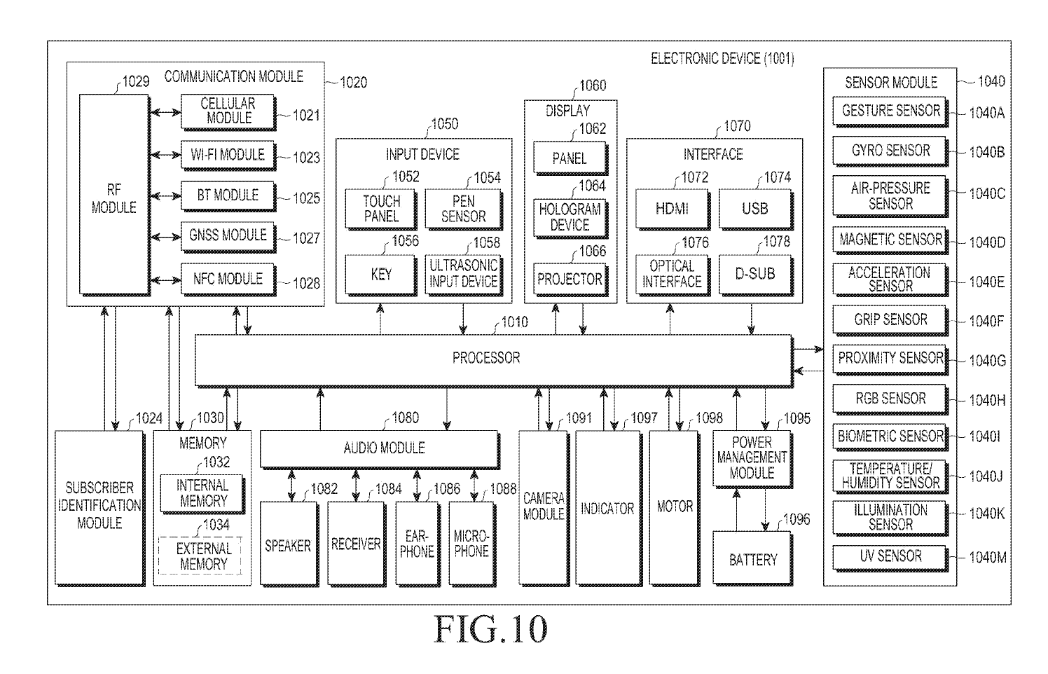

FIG. 10 is a block diagram illustrating an electronic device 1001 according to an embodiment of the present disclosure. The electronic device 1001 may include the whole or part of, e.g., the electronic device 901. The electronic device 1001 may include one or more processors (e.g., APs) 1010, a communication module 1020, a subscriber identification module (SIM) 1024, a memory 1030, a sensor module 1040, an input device 1050, a display 1060, an interface 1070, an audio module 1080, a camera module 1091, a power management module 1095, a battery 1096, an indicator 1097, and a motor 1098. The processor 1010 may control multiple hardware and software components connected to the processor 1010 by running, e.g., an OS or application programs, and the processor 1010 may process and compute various data. The processor 1010 may be implemented in, e.g., a system on chip (SoC). The processor 1010 may further include a graphic processing unit (GPU) and/or an image signal processor (ISP). The processor 1010 may include at least some (e.g., the cellular module 1021) of the components of the electronic device 1001. The processor 1010 may load a command or data received from at least one of other components (e.g., a non-volatile memory) on a volatile memory, process the command or data, and store the resultant data in the non-volatile memory.

The communication module 1020 may have the same or similar configuration to the communication interface 970. The communication module 1020 may include, e.g., a cellular module 1021, a wireless fidelity (Wi-Fi) module 1023, a Bluetooth™ (BT) module 1025, a GNSS module 1027, a NFC module 1028, and a RF module 1029. The cellular module 1021 may provide voice call, video call, text, or Internet services through, e.g., a communication network. The cellular module 1021 may perform identification or authentication on the electronic device 1001 in the communication network using a SIM 1024 (e.g., a SIM card). The cellular module 1021 may perform at least some of the functions provided by the processor 1010. The cellular module 1021 may include a CP. According to an embodiment of the present disclosure, at least some (e.g., two or more) of the cellular module 1021, the Wi-Fi module 1023, the BT module 1025, the GNSS module 1027, or the NFC module 1028 may be included in a single integrated circuit (IC) or an IC package. The RF module 1029 may communicate data, e.g., communication signals. The RF module 1029 may include, e.g., a transceiver, a power amp module (PAM), a frequency filter, a low noise amplifier (LNA), or an antenna. At least one of the cellular module 1021, the Wi-Fi module 1023, the BT module 1025, the GNSS module 1027, or the NFC module 1028 may communicate RF signals through a separate RF module. The SIM 1024 may include, e.g., a card including a SIM, or an embedded SIM, and may contain unique identification information (e.g., an integrated circuit card identifier (ICCID) or subscriber information (e.g., an international mobile subscriber identity (IMSI)).

The memory 1030 may include, e.g., an internal memory 1032 or an external memory 1034. The internal memory 1032 may include at least one of, e.g., a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 1034 may include a flash drive, e.g., a compact flash (CF) memory, a secure digital (SD) memory, a micro-SD memory, a min-SD memory, an extreme digital (xD) memory, a multi-media card (MMC), or a Memory Stick™. The external memory 1034 may be functionally or physically connected with the electronic device 1001 via various interfaces.

The sensor module 1040 may measure a physical quantity or detect an operational state of the electronic device 1001, and the sensor module 1040 may convert the measured or detected information into an electrical signal. The sensor module 1040 may include at least one of, e.g., a gesture sensor 1040A, a gyro sensor 1040B, an atmospheric pressure sensor 1040C, a magnetic sensor 1040D, an acceleration sensor 1040E, a grip sensor 1040F, a proximity sensor 1040G, a color sensor 1040H (e.g., a red-green-blue (RGB) sensor), a bio sensor 1040I, a temperature/humidity sensor 1040J, an illumination sensor 1040K, or an ultra violet (UV) sensor 1040M. Additionally or alternatively, the sensing module 1040 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 1040 may further include a control circuit for controlling at least one or more of the sensors included in the sensing module. According to an embodiment of the present disclosure, the electronic device 1001 may further include a processor configured to control the sensor module 1040 as part of the processor 1010 or separately from the processor 1010, and the electronic device 1001 may control the sensor module 1040 while the processor 1010 is in a sleep mode.

The input unit 1050 may include, e.g., a touch panel 1052, a (digital) pen sensor 1054, a key 1056, or an ultrasonic input device 1058. The touch panel 1052 may use at least one of capacitive, resistive, infrared, or ultrasonic methods. The touch panel 1052 may further include a control circuit. The touch panel 1052 may further include a tactile layer and may provide a user with a tactile reaction. The (digital) pen sensor 1054 may include, e.g., a part of a touch panel or a separate sheet for recognition. The key 1056 may include e.g., a physical button, optical key, or key pad. The ultrasonic input device 1058 may sense an ultrasonic wave generated from an input tool through a microphone 1088 to identify data corresponding to the sensed ultrasonic wave.

The display 1060 may include a panel 1062, a hologram device 1064, a projector 1066, and/or a control circuit for controlling the same. The panel 1062 may be implemented to be flexible, transparent, or wearable. The panel 1062, together with the touch panel 1052, may be configured in one or more modules. According to an embodiment of the present disclosure, the panel 1062 may include a pressure sensor or force sensor that may measure the strength of a pressure by the user's touch. The pressure sensor may be implemented in a single body with the touch panel 1052 or may be implemented in one or more sensors separate from the touch panel 1052. The hologram device 1064 may make three dimensional (3D) images (e.g., holograms) in the air by using light interference. The projector 1066 may display an image by projecting light onto a screen. The screen may be, for example, located inside or outside of the electronic device 1001.

The interface 1070 may include e.g., an HDMI 1072, a USB 1074, an optical interface 1076, or a D-subminiature (D-sub) 1078. The interface 1070 may be included in e.g., the communication interface 970. Additionally or alternatively, the interface 1070 may include an MHL interface, an SD card/multimedia card (MMC) interface, or an Infrared Data Association (IrDA) standard interface.

The audio module 1080 may convert, e.g., a sound signal into an electrical signal and vice versa. At least a part of the audio module 1080 may be included in e.g., the input/output interface 950. The audio module 1080 may process sound information input or output through, e.g., a speaker 1082, a receiver 1084, an earphone 1086, or the microphone 1088. The camera module 1091 may be a device for capturing still images and videos, and may include, according to an embodiment of the present disclosure, one or more image sensors (e.g., front and back sensors), a lens, an ISP, or a flash such as an LED or xenon lamp. The power manager module 1095 may manage power of the electronic device 1001, for example. The power manager module 1095 may include a power management integrated circuit (PMIC), a charger IC, or a battery gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 1096, a voltage, a current, or a temperature while the battery 1096 is being charged. The battery 1096 may include, e.g., a rechargeable battery or a solar battery.

The indicator 1097 may indicate a particular state of the electronic device 1001 or a part (e.g., the processor 1010) of the electronic device, including, e.g., a booting state, a message state, or recharging state. The motor 1098 may convert an electric signal to a mechanical vibration and may generate a vibrational or haptic effect. The electronic device 1001 may include a mobile TV supporting device (e.g., a GPU) that may process media data as per, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments of the present disclosure, the electronic device 1001 may exclude some elements or include more elements, or some of the elements may be combined into a single entity that may perform the same function as by the elements before combined.

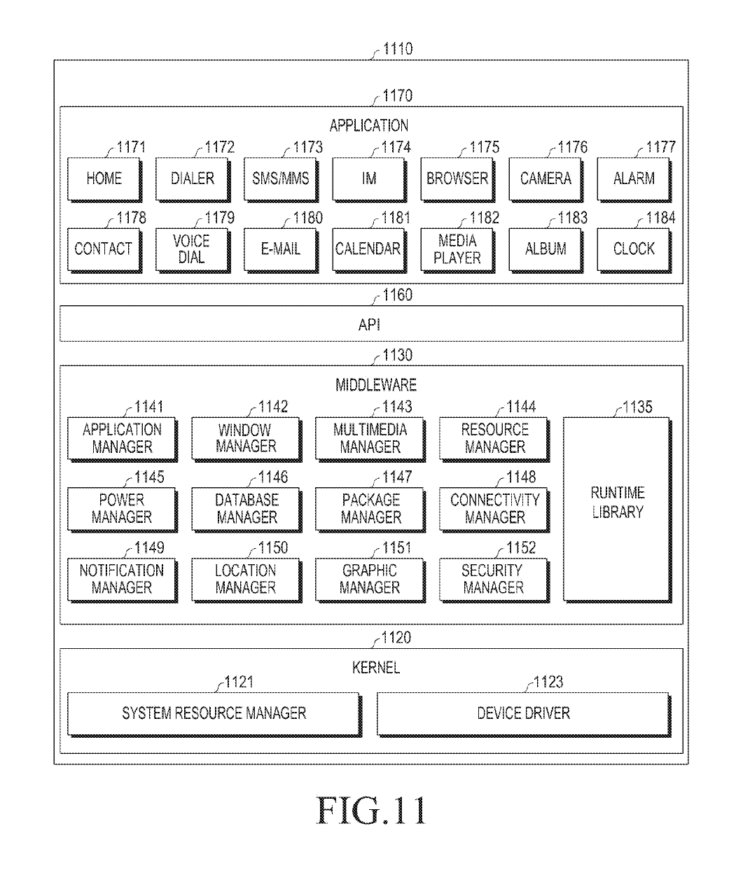

FIG. 11 is a block diagram illustrating a program module according to an embodiment of the present disclosure. The program module 1110 may include an OS controlling resources related to the electronic device 1001 and/or applications 947 driven on the operating system. The OS may include, e.g., Android™, iOS™, Windows′, Symbian™, Tizen™, or Bada™. Referring to FIG. 11, the program module 1110 may include a kernel 1120, middleware 1130, an API 1160, and/or applications 1170. At least a part of the program module 1110 may be preloaded on the electronic device or may be downloaded from an external electronic device (e.g., the electronic devices 902 and 904, or server 906).

The kernel 1120 may include, e.g., a system resource manager 1121 or a device driver 1123. The system resource manager 1121 may perform control, allocation, or recovery of system resources. According to an embodiment of the present disclosure, the system resource manager 1121 may include a process managing unit, a memory managing unit, or a file system managing unit. The device driver 1123 may include, e.g., a display driver, a camera driver, a Bluetooth™ driver, a shared memory driver, a USB driver, a keypad driver, a Wi-Fi driver, an audio driver, or an inter-process communication (IPC) driver.

The middleware 1130 may provide various functions to the applications 1170 through the API 1160 so that the application 1170 may use limited system resources in the electronic device or provide functions jointly required by applications 1170. According to an embodiment of the present disclosure, the middleware 1130 may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, or a security manager 1152.

The runtime library 1135 may include a library module used by a compiler in order to add a new function through a programming language while, e.g., the applications 1170 are being executed. The runtime library 1135 may perform input/output management, memory management, or arithmetic function processing. The application manager 1141 may manage the life cycle of, e.g., the applications 1170. The window manager 1142 may manage GUI resources used on the screen. The multimedia manager 1143 may be aware of formats necessary to play media files and use a codec appropriate for the format to perform encoding or decoding on the media files. The resource manager 1144 may manage source code or memory space of the applications 1170. The power manager 1145 may manage, e.g., the battery capability or power, and provide power information necessary for the operation of the electronic device. According to an embodiment of the present disclosure, the power manager 1145 may interwork with a basic input/output system (BIOS). The database manager 1146 may generate, search, or vary a database to be used in the applications 1170. The package manager 1147 may manage installation or update of an application that is distributed in the form of a package file.

The connectivity manager 1148 may manage, e.g., wireless connectivity. The notification manager 1149 may provide an event, e.g., arrival message, appointment, or proximity alert, to the user. The location manager 1150 may manage, e.g., locational information on the electronic device. The graphic manager 1151 may manage, e.g., graphic effects to be offered to the user and their related user interface. The security manager 1152 may provide system security or user authentication. According to an embodiment of the present disclosure, the middleware 1130 may include a telephony manager for managing the voice or video call function of the electronic device, or a middleware module able to form a combination of the functions of the above-described elements. The middleware 1130 may provide a module specified according to the type of the OS. The middleware 1130 may dynamically remove some components or add new components. The API 1160 may be a set of, e.g., API programming functions and may have different configurations depending on the OS. For example, in the case of Android or iOS, one API set may be provided per platform, and in the case of Tizen, two or more API sets may be offered per platform.

The applications 1170 may include an application that may provide, e.g., a home application 1171, a dialer application 1172, an SMS/MMS application 1173, an instant message (IM) application 1174, a browser application 1175, a camera application 1176, an alarm application 1177, a contact application 1178, a voice dial application 1179, an email application 1180, a calendar application 1181, a media player application 1182, an album application 1183, or a clock application 1184, a healthcare application (e.g., an application that measures exercise quality or blood sugar level), or an environmental information application (e.g., an application that measures air pressure, moisture, or temperature). According to an embodiment of the present disclosure, the application 1170 may include an information exchanging application supporting information exchange between the electronic device and an external electronic device. Examples of the information exchange application may include, but are not limited to, a notification relay application for transferring information to the external electronic device, or a device management application for managing the external electronic device. For example, the notification relay application may transfer notification information generated by other application of the electronic device to the external electronic device or receive notification information from the external electronic device, and provide the received notification information to the user. The device management application may install, delete, or update a function (e.g., turn-on/turn-off the external electronic device or some elements, or adjusting the brightness or resolution of the display) of the external electronic device communicating with the electronic device or an application operating on the external electronic device. The application 1170 may include an application (e.g., a healthcare application of a mobile medical device) designated according to an attribute of the external electronic device. The application 1170 may include an application received from the external electronic device. At least a portion of the program module 1110 may be implemented (e.g., executed) in software, firmware, hardware, or a combination of at least two or more thereof, and may include a module, program, routine, command set, or process for performing one or more functions.

As used herein, the term “module” includes a unit configured in hardware, software, or firmware, and may interchangeably be used with other terms, e.g., “logic”, “logic block”, “part”, or “circuit.” The module may be a single integrated part, a minimum unit, or part of performing one or more functions. The module may be implemented mechanically or electronically, and may include, e.g., an application specific integrated circuit (ASIC) chip, field programmable gate arrays (FPGAs), or programmable logic device, that has been known or developed in the future to performing some operations. According to an embodiment of the present disclosure, at least a part of the device (e.g., modules or their functions) or method (e.g., operations) may be implemented as instructions stored in a computer-readable storage medium, e.g., in the form of a program module. The instructions, when executed by a processor 1010, may enable the processor to carry out a corresponding function. The computer-readable medium may include, e.g., a hard disk, a floppy disc, a magnetic medium (e.g., magnetic tape), an optical recording medium (e.g., compact disc-read only memory (CD-ROM), DVD, magnetic-optical medium (e.g., floptical disk), or an embedded memory. The instructions may include code created by a compiler or code executable by an interpreter. Modules or programming modules may include at least one or more of the aforementioned components, omit some of them, or further include other additional components. Operations performed by modules, programming modules, or other components may be carried out sequentially, in parallel, repeatedly or heuristically, or at least some operations may be executed in a different order, omitted, or other operations may be added.

As is apparent from the foregoing description, according to an embodiment of the present disclosure, an electronic device may provide a resolution of an image appropriate for the user's view according to the resolution of an image to be played by identifying the resolution of the image, varying the start position of projection of playing the image based on the resolution of the image, and resizing and displaying a portion of the image which is displayed on the image based on the varied start position of projection.

While the present disclosure has been shown and described with reference to various embodiments thereof, it will be understood by those skilled in the art that various changes in form and details may be made therein without departing from the scope of the disclosure as defined by the appended claims and their equivalents.

What is claimed is:

1. An electronic device, comprising:
a display displaying an image; and
a processor electrically connected with the display, wherein the processor is configured to vary a start position of projection, where the image is played based on a resolution of the display and a resolution of the image, and to resize and display a portion of the image which is displayed on the display.

2. The electronic device of claim 1, wherein the image has a 360-degree angle of view.

3. The electronic device of claim 1, wherein the processor is further configured to display a user interface indicating the start position of projection on the display.

4. The electronic device of claim 3, wherein the processor is further configured to allow the user interface indicating the start position of projection to be displayed to include a first component indicating a range in which the start position of projection is variable and a second component indicating a current start position of projection.

5. The electronic device of claim 1, wherein the processor is further configured to vary the start position of projection, where the image is played based on a resolution of the image, and to resize and display a portion of the image which is displayed on the display after the image is displayed for a preset time.

6. The electronic device of claim 4, wherein the processor is further configured to vary the start position of projection, based on entry of an external signal for shifting the second component, and to resize and display the portion of the image which is displayed on the display.

7. The electronic device of claim 6, wherein the processor is further configured to vary the start position of projection, based on a movement of the electronic device, and to resize and display the portion of the image which is displayed on the display.

8. The electronic device of claim 6, wherein, when the electronic device is electrically connected with a wearable device to display the image, the processor is further configured to vary the start position of projection, based on a signal inputted to an input module included in the wearable device or a movement of the wearable device, and to resize and display the portion of the image which is displayed on the display.

9. The electronic device of claim 1, wherein the processor is further configured to vary an angle of view of playing the image, and to resize and display the portion of the image which is displayed on the display.

10. A method for controlling an electronic device including a display, the method comprising:
identifying a resolution of the display and a resolution of an image played;
varying a start position of projection where the image is played based on the resolution of the image; and
resizing and displaying a portion of the image which is displayed on the display based on the varied start position of projection.

11. The method of claim 10, wherein the image has a 360-degree image angle of view.

12. The method of claim 10, further comprising displaying a user interface indicating the start position of projection on the display.

13. The method of claim 12, further comprising allowing the user interface indicating the start position of projection to be displayed to include a first component indicating a range in which the start position of projection is variable and a second component indicating a current start position of projection.

14. The method of claim 10, further comprising resizing and displaying the portion of the image which is displayed on the display based on the varied start position of projection after the image is displayed for a preset time.

15. The method of claim 13, further comprising varying the start position of projection based on entry of an external signal for shifting the second component, and resizing and displaying the portion of the image which is displayed on the display.

16. The method of claim 15, further comprising varying the start position of projection based on a movement of the electronic device, and resizing and displaying the portion of the image which is displayed on the display.

17. The method of claim 15, further comprising, when the electronic device is electrically connected with a wearable device to display the image, varying the start position of projection based on a signal inputted to an input module included in the wearable device or a movement of the wearable device, and resizing and displaying the portion of the image which is displayed on the display.

18. The method of claim 10, further comprising varying an angle of view of playing the image, and resizing and displaying the portion of the image which is displayed on the display.

19. A storage medium storing commands to perform a method for controlling an electronic device including a display, wherein the commands:
identify a resolution of an image played;
vary a start position of projection where the image is played based on the resolution of the image; and
resize and display a portion of the image which is displayed on the display based on the varied start position of projection.
